(19) United States
(12) Patent Application Publication
(10) Pub. No.: US 2026/0209044 A1
(43) Pub. Date: Jul. 23, 2026

(54) MELT PROCESS INVOLVING A DIRECT USE OF A METAL SULFATE PRECURSOR FOR PREPARING A LITHIUM METAL PHOSPHATE CATHODE MATERIAL

(71) Applicant: IGNIS LITHIUM INC., La Prairie (CA)

(72) Inventors: Michel GAUTHIER, La Prairie (CA); Mickael DOLLÉ, Bordeaux (FR); Steeve ROUSSELOT, Montréal (CA); Pierre SAURIOL, Mississauga (CA)

(21) Appl. No.: 19/139,759

(22) PCT Filed: Dec. 14, 2023
(86) PCT No.: PCT/CA2023/051655

§ 371 Date: Jun. 16, 2025

Related U.S. Application Data
(60) Provisional application No. 63/479,271, filed on Jan. 10, 2023.

(51) Int. Cl. C01B 25/45; H01M 4/02; H01M 4/58

(52) U.S. Cl. CPC C01B 25/45; H01M 4/5825; C01P 2002/72; C01P 2002/88; C01P 2006/40; H01M 2004/028

(57) ABSTRACT

There is provided a melt process for preparing a lithium metal phosphate (LMP) cathode material, M being at least one transitional metal. The metal sulfate precursor is used directly with no significant transformation following its extraction from a mine material or recycling from an electrode material of a spent lithium battery. The invention also relates to an LMP cathode material obtained by such process, to a battery having a cathode comprising such material, and to a cathode or battery manufacturing plant which embodies such process.

### CROSS-REFERENCE TO RELATED APPLICATIONS

The present application claims the benefit of U.S. Provisional Patent Application No. 63/479,271 filed on Jan. 10, 2023. The content of this application is incorporated herein in its entirety by reference.

### FIELD OF THE INVENTION

The present invention relates generally to melt processes using metal sulfate precursors for preparing a lithium metal phosphate (LMP) cathode material. More specifically, the invention relates to a melt process wherein the metal sulfate precursor is used directly with no significant transformation following its extraction from a mine material or recycling from an electrode material of a spent lithium battery. Moreover, the invention relates to an LMP cathode material obtained by such process, to a battery having a cathode comprising such material, and to a cathode or battery manufacturing plant which embodies such process.

### BACKGROUND OF THE INVENTION

Lithium Metal Phosphate (LMP) cathode of the olivine structure, especially Lithium Iron Phosphate (LFP) and Lithium Iron Manganese Phosphate (LFMP) of the general LiFeₓMn₁₋ₓPO₄ composition in which x varies between 0 and 1 are becoming the cathodes of choice in most lithium battery technologies. The choice is based on their performance, long-term cycle life, stability, non-toxicity, and more importantly their potential for cost reduction.

Iron (and phosphorous) availability and cost, as opposed to cobalt and nickel presently used in alternate lithium metal oxide cathodes, leave lithium as the major material cost contributor in phosphate-based cathodes. Most of the time for cathode synthesis, lithium is introduced as lithium hydroxide LiOH or as lithium carbonate Li₂CO₃, which constitute the standard lithium chemicals obtained from brines or spodumene minerals transformation. Usually, the reactions for cathode material synthesis are reactant-specific and optimised for one of those two chemicals. For example, most of the LFP presently sold is made by a solid-state thermal reaction between Li₂CO₃ and FePO₄ as disclosed for example in WO 02/27823 A1 and WO 02/27824, and most lithium nickel manganese cobalt oxide (NMC) cathodes use specifically a LiOH precursor.

As for lithium precursors presently in use, such as Li₂CO₃, the metal main precursor presently used to make LFP, FePO₄, is obtained from FeSO₄ that is oxidized with H₂O₂ and treated with a sodium phosphate salt to form FePO₄ along with waste salt, e.g., Na₂SO₄.

The discovery of a melt process as an efficient and rapid way to make LFP and LFMP (WO 2005/062404 A1, WO 2013/177671 A1, and WO 2015/179972 A1) has led to several cost improvements by enabling the use of iron oxide, iron metal, and even concentrated iron mineral instead of more transformed iron precursors such as FePO₄ or FeC₂O₄.

Typically, lithium precursors used in the lithium-battery industry stem from mine materials or cathode and anode recycling materials. Lithium sulfate is frequently an intermediate species to produce the desired Li₂CO₃ and LiOH precursors. In the same manner, iron sulfate from ilmenite mineral treatment is the starting intermediate to make FePO₄. Some challenges facing the industry relate to the requirement to significantly reduce or eliminate transformation steps associated to these precursors. This requirement is necessary to minimize the impact on the environment and to reduce costs.

There is a need for improved melt processes for preparing lithium metal phosphate cathode materials. In particular, there is a need for such processes wherein precursors used undergo a minimum transformation, leading to cost-efficient and environmentally friendly processes.

### SUMMARY OF THE INVENTION

The inventors have developed and performed a melt process comprising use of a metal sulfate precursor for preparing a lithium metal phosphate (LMP) cathode material, wherein the metal sulfate precursor is used directly with no significant transformation following its extraction from a mine material or recycling from an electrode material of a spent lithium battery. Such metal sulfate precursor is for example Li₂SO₄, FeSO₄, or MnSO₄. The cost and environmental benefits of the process according to the invention result from climbing up the mineral supply chain.

In embodiments of the invention, a mixture of two or three of the metal sulfate precursors is used.

In embodiments of the invention, a mixture of the Li₂SO₄ precursor and one the FeSO₄ and MnSO₄ precursors is used.

In embodiments of the invention, a hydrated form of the metal sulfate precursor is used.

In embodiments of the invention involving use of the Li₂SO₄ precursor, it is in the form of a mixture comprising Li₂SO₄ and Li₃PO₄. The mixture is obtained after subjecting the lithium sulfate to a precipitation process.

In embodiments of the invention involving use of the Li₂SO₄ precursor, it is substantially free of Li₂CO₃ or LiOH.

In embodiments of the invention involving use of the Li₂SO₄ precursor, its hydrated form is of general formula Li₂SO₄·xH₂O, wherein x varies from about 0 to about 30, or from about 1 to about 5, or from about 0 to about 3, or x is 1, or x is 2.

In embodiments of the invention, at least one other source of the metal is used. For the iron, the at least one source may be Fe⁰, FeO, Fe₂O₃, Fe₃O₄, ferrous phosphate, ferric phosphate, or a mixture thereof including an iron oxide concentrated mineral. The sources of iron are adjusted to fix the oxidation state at +2 for the iron.

In embodiments of the invention, for the preparation of LFMP, the other source of Mn may be Mn⁰, MnO, Mn₂O₃, MnO₂, MnCO₃, or a mixture thereof.

In embodiments of the invention, a source of phosphorus or phosphate (source of P or PO₄) may be P₂O₅, HPO₃, (NH₄)H₂PO₄ (monoammonium phosphate; MAP), (NH₄)₂HPO₄ (diammonium phosphate; DAP) and mineral apatite such as Ca₅(PO₄)₃(OH). The source of PO₄ is suitably selected such as to avoid or significantly reduce the emission of SO₂ or SO₃ gasses.

In embodiments of the invention, the metal sulfate precursor is added to the melt simultaneously with the source of PO₄.

In embodiments of the invention, the metal sulfate precursor is subjected to an initial melting process thereby obtaining an initial molten reactive pool, and the source of PO₄ is added therein.

In embodiments of the invention, there is provided an LMP or LiMPO₄ cathode material which is LFP or LiFePO₄. Also, there is provided an LMP cathode material which is LiMnPO₄. The LMP or LFP cathode material is obtained by the melt process according to the invention, and has a sulfur contain of 0.1% or less as measured by LECO sulfur analysis.

In embodiments of the invention, there is provided an LFMP or LiFeₓMn₁₋ₓPO₄ in which x varies between 1 and 0 cathode material. The LFMP cathode material is obtained by the melt process according to the invention, and has a sulfur contain of 0.1% or less as measured by LECO sulfur analysis.

In embodiments of the invention, there is provided a battery having a cathode which comprises an LMP, LFP, or LFMP material obtained by the melt process according to the invention.

In embodiments of the invention, there is provided a cathode or battery manufacturing plant, which embodies the melt process according to the invention.

The invention thus provides the following in accordance with aspects thereof:
(1) A melt process for preparing a lithium metal phosphate (LMP) cathode material, M being at least one transitional metal, the process comprising use of a metal sulfate precursor which is Li₂SO₄, FeSO₄, MnSO₄, or a hydrated form thereof, or a mixture thereof, wherein the metal sulfate precursor is used directly with no significant transformation.
(2) The melt process according to (1) above, wherein the metal sulfate precursor is obtained following its extraction from a mine material or recycling from an electrode material of a spent lithium battery; optionally the metal sulfate precursor is obtained as product of a chemical process.
(3) The melt process according to (1) or (2) above, wherein the LMP cathode material is of the olivine structure; optionally the LMP is lithium iron phosphate (LFP), or lithium iron manganese phosphate (LFMP).
(4) The melt process according to any one of (1) to (3) above, wherein the mine material is spodumene.
(5) The melt process according to any one of (1) to (4) above, wherein the metal sulfate precursor is a mixture of the Li₂SO₄ and one of FeSO₄ and MnSO₄.
(6) The melt process according to any one of (1) to (4) above, wherein the metal sulfate precursor is a mixture of Li₂SO₄, FeSO₄, and MnSO₄.
(7) The melt process according to any one of (1) to (6) above, wherein the Li₂SO₄ precursor is used as a mixture comprising Li₂SO₄ and Li₃PO₄; optionally, the mixture is obtained after subjecting the Li₂SO₄ to a precipitation process.
(8) The melt process according to any one of (1) to (7) above, wherein the Li₂SO₄ precursor is substantially free of Li₂CO₃ or LiOH.
(9) The melt process according to any one of (1) to (8) above, wherein the hydrated form of the Li₂SO₄ precursor of general formula Li₂SO₄·xH₂O, wherein x varies from about 0 to about 30, or from about 1 to about 5, or from about 0 to about 3, or x is 1, or x is 2.
(10) The melt process according to any one of (1) to (9) above, wherein at least one other source of the metal is used.
(11) The melt process according to any one of (1) to (10) above, wherein at least one other source of Fe is used; preferably the at least other source of Fe is Fe⁰, FeO, Fe₂O₃, Fe₃O₄, ferric phosphate, or a mixture thereof including an iron oxide concentrated mineral; preferably the sources of Fe are adjusted such as to fix the oxidation state at +2 for Fe.
(12) The melt process according to any one of (1) to (11) above, wherein at least one other source of Mn is used; preferably the at least other source of Mn is Mn⁰, MnO, Mn₂O₃, MnO₂, MnCO₃, or a mixture thereof.
(13) The melt process according to any one of (1) to (12) above, wherein at least one source of phosphorus or phosphate (source of P or PO₄) is used; preferably the source of P or PO₄ is P₂O₅, HPO₃, (NH₄)H₂PO₄ (monoammonium phosphate; MAP), (NH₄)₂HPO₄ (diammonium phosphate; DAP), or mineral apatite such as Ca₅(PO₄)₃(OH); preferably the source of PO₄ is suitably selected such as to avoid or significantly reduce any emission of SO₂ and/or SO₃ gasses.
(14) The melt process according to any one of (1) to (13) above, wherein the metal sulfate precursor is added to the melt simultaneously with the source of PO₄.
(15) The melt process according to any one of (1) to (12) above, wherein at least one source of phosphorus or phosphate (source of P or PO₄) is used which is (NH₄)H₂PO₄ (monoammonium phosphate; MAP) or (NH₄)₂HPO₄ (diammonium phosphate; DAP), and (NH₄)₂SO₄ is formed as a by-product; preferably MAP and DAD are used simultaneously with the metal sulfate precursor; preferably emission of SO₂ and/or SO₃ gasses is eliminated or is significantly reduced.
(16) The melt process according to (13) above, wherein the metal sulfate precursor is subjected to an initial melting process thereby obtaining an initial molten reactive pool, and the source of PO₄ is added therein.
(17) The melt process according to (2) above, wherein the mine material or the electrode material of a spent lithium battery is subjected to a treatment comprising thermal treatment and/or acid leaching and/or crystallisation to yield the metal sulfate precursor.
(18) The process according to any one of (1) to (17) above, wherein a temperature of the melt is between about 850° C. and about 1300° C., and a reaction melt is held at substantially the same temperature; preferably under an inert or reducing atmosphere; preferably the inert or reducing atmosphere comprises CO₂, CO, H₂, H₂O, Ar, N₂, CH₄, and natural gas; preferably in proportions suitable to stabilize the cathode composition in the melt and upon casting and solidification; preferably under stirring.
(19) The melt process according to (16) above, wherein the reaction melt is further fixed such that upon casting and solidification the LMP in solid crystalline form is obtained; optionally the solid crystalline LMP is reduced to powder; optionally the powdered solid crystalline LMP is coated with carbon to form an electrochemically active cathode material; preferably the carbon coating process uses a carbon precursor.
(20) A metal sulfate precursor for use directly in a melt process for the preparation of a lithium metal phosphate (LMP) cathode material, M being at least one transitional metal, wherein the metal sulfate precursor is Li₂SO₄, FeSO₄, MnSO₄, or a hydrated form thereof, or a mixture thereof, and wherein the metal sulfate precursor is suitable for use directly with no significant transformation; optionally the metal sulfate precursor is obtained following its extraction from a mine material or recycling from an electrode material of a spent lithium battery; optionally the metal sulfate precursor is obtained as product of a chemical process.
(21) An LMP, LFP, or LFMP cathode material made by the melt process as defined in any one of (1) to (19) above, which contains about 0.1% or less sulfur as measured by LECO sulfur analysis.
(22) A cathode comprising a material made by the melt process as defined in any one of (1) to (19) above.
(23) A battery having a cathode comprising the material made by the melt process as defined in any one of (1) to (19) above.
(24) A cathode or battery manufacturing plant which embodies the melt process as defined in any one of (1) to (19) above.
(25) Use of a metal sulfate precursor in a melt process for preparing a lithium metal phosphate (LMP) cathode material, M being at least one transitional metal, wherein the metal sulfate precursor is Li₂SO₄, FeSO₄, MnSO₄, or a hydrated form thereof, or a mixture thereof, and wherein the metal sulfate precursor is used directly with no significant transformation; optionally the metal sulfate precursor is obtained following its extraction from a mine material or recycling from an electrode material of a spent lithium battery; optionally the metal sulfate precursor is obtained as product of a chemical process.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the appended drawings:

FIG. 1a: XRD pattern on the product of Example 1

FIG. 1b: TGA curves of the reaction of Example 1

FIG. 1c: Corresponding MS result coupled with the TGA

FIG. 1d: Charge and discharge capacity of product of Example 1

FIG. 2a: XRD pattern of the product of Example 2a

FIG. 2b: XRD pattern of the Li precursor of Example 2b

FIG. 3a: XRD pattern of the product of Example 4

FIG. 3b: XRD pattern of the by-product of Example 4

FIG. 4a: XRD spectra confirming the apatite Ca₁₀(PO₄)₆(OH)₂ structure

FIG. 4b: XRD spectra showing the formation of Li₃PO₄ and CaSO₄

FIG. 5a: XRD pattern of the product of Example 7.

### DESCRIPTION OF ILLUSTRATIVE EMBODIMENTS

Before the present invention is further described, it is to be understood that the invention is not limited to the particular embodiments described below, as variations of these embodiments may be made and still fall within the scope of the appended claims. It is also to be understood that the terminology employed is for the purpose of describing particular embodiments; and is not intended to be limiting. Instead, the scope of the present invention will be established by the appended claims.

In order to provide a clear and consistent understanding of the terms used in the present specification, a number of definitions are provided below. Moreover, unless defined otherwise, all technical and scientific terms as used herein have the same meaning as commonly understood to one of ordinary skill in the art to which this disclosure pertains.

Use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

As used herein, the term “metal sulfate precursor” refers a compound such as Li₂SO₄, FeSO₄, or MnSO₄, used in the preparation of a lithium metal phosphate (LMP) cathode material. This term also refers to a hydrated form of such compound. Moreover, this term refers to a mixture of two or more of such compounds and/or hydrated forms thereof. In particular, the term “lithium sulfate precursor” refers to the compound Li₂SO₄ a hydrated form thereof, or a mixture of Li₂SO₄ and one or more other metal sulfate precursors and/or hydrated forms thereof. Also, the term “lithium sulfate precursor” refers to the mixture Li₂SO₄ and Li₃PO₄.

As used herein, the term “direct use” as it relates to the introduction in the melt of the metal sulfate precursor, refers to a use without prior conversion of the metal sulfate to other reactants. For example, direct introduction of the Li₂SO₄ precursor refers to a use without prior conversion to Li₂CO₃ or LiOH as currently known in the art. In other embodiments of the invention the metal sulfate precursor can be subjected to an initial melting process prior to use as a melt reaction pool. For example, the Li₂SO₄ can be partially precipitated as Li₃PO₄ prior to use, a mixture of Li₂SO₄ and Li₃PO₄ is thus used. In embodiments of the invention, the metal sulfate precursor is subjected to known purification techniques such as crystallization and filtration. It should be noted that such partial precipitation, initial melting process, and purification techniques are not considered significant transformations. The term “direct introduction” or a variant thereof is also used and refers to the same thing. Accordingly, herein, the terms “direct use” and “direct introduction” are used interchangeably.

The inventors have designed and developed and performed a melt process comprising use of a metal sulfate precursor for preparing a lithium metal phosphate (LMP) cathode material. The metal sulfate precursor is used directly with no significant transformation following its extraction from a mine material or recycling from an electrode material of a spent lithium battery. The metal sulfate precursor may also be the product of a chemical process. The metal sulfate precursor is for example Li₂SO₄, FeSO₄, or MnSO₄.

In the present invention, the melt process versatility for reactant selection is put at profit to further optimise the lithium cost contribution by using other lithium chemical intermediates, e.g., Li₂SO₄, that are present or that can be formed in the initial steps of lithium salt extraction of minerals or from other chemical sources such as recycling or by-product of other chemical processes.

Particularly relevant are the lithium salt, e.g., Li₂SO₄, extraction from spodumene mineral, LiAlSi₂O₆, or obtained from the recycling of spent cathode from used batteries that can be used as such or at least partially precipitated as Li₃PO₄ to illustrate the interest of the present invention.

In most industrial processes converting spodumene to Li₂CO₃ or LiOH, the initial steps include at least: mineral grinding, heat treatment to β-spodumene, extraction with H₂SO₄ to form Li₂SO₄, addition of Na₂CO₃ to form Li₂CO₃ with optional addition of Ca(OH)₂ to further form LiOH, followed by crystallisation and a final grinding step. Treatment of spodumene to form Li₂SO₄ is described for example in: China Geology, Volume 6, Issue 1, January 2023, Pages 137-153. Treatment of spent battery material to form Li₂SO₄ is described for example in: Ionics (2019) 25:5643-5653, and Materials 2020, 13, 801; doi:10.3390/ma13030801. The typical reactions involved can be summarized as:

For oxides:

$${LiMO}_{2} ( M = Ni , Li , Co , Mn ) : 2 {LiMO}_{2} + 3 {H}_{2} {SO}_{4} = > {Li}_{2} {SO}_{4} + 2 M {SO}_{4} + 3 {H}_{2} O + 1 / 2 {O}_{2}$$

And for LFP:

$$2 {LiFePO}_{4} + {H}_{2} {SO}_{4} + {H}_{2} {O}_{2} \to 2 {FePO}_{4} + {Li}_{2} {SO}_{4} + 2 {H}_{2} O .$$

Some intermediate purification steps are sometimes added to meet the stringent requirements of most cathode battery materials synthesis processes. In the present invention the Li₂SO₄ intermediate can be used directly in the melt process of the invention, optionally after simple recrystallization or used after a partial precipitation as Li₃PO₄ with some residual Li₂SO₄, both reactants being compatible with the melt process. Such a mixture is relatively simple to obtain and avoid further separation steps between Li₂SO₄ and Li₃PO₄.

Direct use of a lithium precursor such as Li₂SO₄ without conversion to Li₂CO₃ or LiOH is not used in reactant specific solid-state processes currently applied by the industry despite the cost advantage of the lithium sulfate intermediate currently produced to obtain lithium carbonate or hydroxide. Its direct use in the melt process of the invention was in principle possible but not obvious and practiced either considering the multiple reactional paths possible at the melt temperature, the reductive atmosphere selected and the possible formation of mixed phosphate-sulfate compositions such as Li₃Fe(SO₄) (PO₄) all teach away from sulfate-based precursors given sulfate stability. No description of the feasibility and how to totally convert Li₂SO₄ or Li₂SO₄·xH₂O into LMP in a melt synthesis is known or described in the art.

Using various Fe, Mn, and PO₄ melt precursors in the present invention, it was found possible to use said Li₂SO₄ or Li₂SO₄-containing precursor as a low-cost reactant to make LiFeₓM₁₋ₓPO₄ cathode compositions in which x varies for 0 to 1. For example, surprisingly, LFP or LFMP ingots made from Li₂SO₄ were found to contain less that 0.1% sulfur as measured from LECO sulfur analysis. Doing so reduces the number of steps and cost to make the cathode material directly from Li₂SO₄ intermediate obtained from mineral treatment. This intermediate chemical, Li₂SO₄, is currently used by the industry to make Li₂CO₃ and LiOH reactants from lithium mineral or obtained as a product from spent cathode material from used battery recycling.

A non-limitative illustration of the global reaction involved with the lithium sulfate precursor and the melt process of the invention can be represented as follows:

$$L {i}_{2} S {O}_{4} + 2 FeO + {P}_{2} {O}_{5} = 2 {LiFePO}_{4} + S {O}_{3} \qquad Eq . 1$$

$$or as :$$

$$2 {Li}_{2} S {O}_{4} + 4 FeO + 2 {P}_{2} {O}_{5} = 4 {LiFePO}_{4} + 2 {SO}_{2} + {O}_{2} \qquad Eq . 2$$

For simplification FeO formalism is used while in fact an equivalent mixture of Fe₂O₃ and Fe is used given FeO instability under 650° C.

Other different reactions are possible, nevertheless, depending on temperature and oxygen partial pressure, pO₂, as well as the Fe, Mn, or P exact nature or combination.

It was also surprisingly found that when (NH₄)H₂PO₄ (monoammonium phosphate; MAP) or (NH₄)₂HPO₄ (diammonium phosphate; DAP) is used as a phosphorus source in the melt process along with Li₂SO₄, LiFePO₄ is obtained with a useful (NH₄)₂SO₄ by-product formed, thus avoiding or greatly reducing any SO₂ or SO₃ gas emission. Although not limited as the sole mechanism for this surprising observation, the following reaction can be suggested:

$$L {i}_{2} S {O}_{4} + 2 ( {NH}_{4} ) {H}_{2} P {O}_{4} + 2 FeO = 2 {LiFePO}_{4} + {( {NH}_{4} )}_{2} {SO}_{4} + 2 {H}_{2} O \qquad Eq . 3$$

Also, the following reactions can be suggested in relation to the FeSO₄ precursor:

$$Li ++ {( NH 4 )}_{2} {HPO}_{4} + {FeSO}_{4} = {LiFePO}_{4} + {( NH 4 )}_{2} {SO}_{4} + 2 {H}_{2} O$$

$$2 Li ++ 2 ( {NH}_{4} ) {H}_{2} {PO}_{4} + 2 {FeSO}_{4} = 2 {LiFePO}_{4} + {( NH 4 )}_{2} {SO}_{4} + {SO}_{2} + 2 {H}_{2} O$$

Several other reactions could occur depending specially on the reducing atmosphere use and the sequence of introducing the reactants. However, the main point of interest is the possibility to avoid or reduce sulfur anhydrides by forming ammonium sulfate that is a valuable by-product, e.g., a fertilizer.

The invention illustrates the conversion of a lithium sulfate precursor into lithium metal phosphate olivine through the melt process. The inventors further extended to the use of transition metal sulfate precursors such as FeSO₄ and MnSO₄ which are frequently used as intermediates to form the equivalent metal phosphate, e.g., FePO₄ or LFMP compositions. Although in the North American context iron oxide or metal are preferred as precursors to be used directly in the melt, for their simplicity of use, the possibility to convert transition metal sulfates into equivalent lithium metal phosphate in the melt to obtain electrochemically active olivine cathode material is also of interest given the availability of MnSO₄, for example, from the large volume of oxide cathode production, e.g., NMC.

Other patents and published patent applications on molten processes cited in the present application describe typical conditions of operation of molten salt synthesis also used in the present invention, especially WO 2013/177671 A1 and WO 2015/179972 A1. Co-pending applications U.S. 63/479,266 and U.S. 63/479,276 also describe additional mode of realization encompassed in the present invention. It is a specificity of the melt synthesis to enable slight deviations from pure stoichiometry even after solidification. For example, substitution elements can be observed in certain conditions after solidification, such as when some Mg, Ca, Zn, Ni, Co, Al, or Si are present in the melt during the synthesis. The formula encompasses these composition deviations as long as the useful structure remains olivine and the electrochemical capacity to exchange lithium ions is not significantly reduced, e.g., less than 15 mAh/g vs. the theoretical capacity of 170 mAh/g.

Using such lithium sulfate intermediate chemical directly in the melt process reduces the number of operations usually required to convert a lithium mineral to Li₂CO₃ or LiOH as well as the cost to buy Na₂CO₃ chemical and discard by-product such as Na₂SO₄ which may become a non-desired contaminant for the battery life cycle. Similarly, in general, using such metal sulfate intermediate chemical directly in the melt process reduces the number of operations usually required to convert a lithium mineral to FePO₄ or MnPO₄ as well as the cost to buy Na₂CO₃ chemical and discard by-product such as Na₂SO₄.

In another variant of the invention, it was found possible and useful to convert and precipitate at least partially, the Li₂SO₄ intermediate to insoluble Li₃PO₄ rich precursor. Such a precipitation step facilitates the lithium separation of the lithium precursor, as Li₃PO₄ mixed with a small amount of Li₂SO₄. This precipitate can be directly used in the melt process of the invention to obtain pure LFP or LFMP containing no or less than 0.1% sulfur as confirmed by LECO sulfur analysis. Total sulfate conversion to phosphate in the melt to form lithium metal phosphate compositions that lead to olivine structure upon solidification being especially favorable thermodynamically as observed in the examples.

In another variant of the invention, Li₂SO₄, having a low melting point of about 850° C., can be used as initial molten reactive pool to which the other precursors for Fe, Mn, or PO₄ can be added to form the desired LiFeₓMn₁₋ₓPO₄ composition in which x varies between 0 and 1.

In such a case, Li₂SO₄ can be adjusted to the melt stoichiometric composition or planned in excess so that after casting and solidification of the olivine crystals an additional water soluble Li₂SO₄ phase remains that can be washed. Although not optimized in the present invention, it was found nevertheless in the present invention that a Li₂SO₄ lithium precursor can be used along with a concentrated apatite mineral of the Ca₅(PO₄)₃(OH) composition to form Li₃PO₄ and CaSO₄ with no or less sulfur oxide releases with the melt process of the invention. Furthermore, the same Li₂SO₄ lithium precursor can be used along with a concentrated apatite mineral of the Ca₅(PO₄)₃(OH) in the presence of a Fe and/or Mn⁺² precursor and additional P₂O₅ in the right proportions to form LiFePO₄ or LiFeₓMn₁₋ₓPO₄ olivine crystal as will be shown in the following examples. In such cases trapping most SO₃ or SO₂ gas formed as CaSO₄ constitutes an additional benefit of the invention.

Both the use of Li₂SO₄ and apatite mineral as Li and P sources made possible in the present invention would significantly reduce the number of chemical steps and wastes to form lithium metal phosphate cathodes.

Obviously other sources of Li₂SO₄ could be used for the present invention, but a useful mode of realisation of the invention is to use such a lithium sulfate precursor in the melt process of the invention as a continuation of the initial steps of the lithium extraction from the spodumene mineral by thermal treatment and acid leaching but also as a by-product of spent cathode recycling from end-of-life battery.

Although precursor introduction directly in the melt used as a reaction pool is preferred in the present invention as described in WO 2013/177671 A1 for rapidity and homogeneity of the reaction, it is nevertheless possible to melt at least one component and react progressively and simultaneously as exemplified in the following examples for the sake of simplicity with small laboratory equipment.

### EXAMPLES

### Example 1

A C—LiFePO₄ cathode is made using the following mixture of precursors in their solid powder form: Li₂SO₄·H₂O, Fe⁰, Fe₂O₃, and P₂O₅. In order to reproduce the essential of the recycling process of spent oxide cathodes as described in Materials 2020, 13, 801; doi:10.3390/ma13030801, the monohydrated lithium sulfate used for this example is obtained from H₂SO₄ leaching of LiCoO₂, the acid solution neutralized with an ammonium hydroxide solution and the hydrate Li₂SO₄ separated by crystallization.

The proportion of each reactant is adjusted to respect the stoichiometry 1.03, 1,1.03 for the lithium, iron, and phosphorus ratio in the final LFP composition. The two sources of iron are adjusted to fix the oxidation state +2 for the iron.

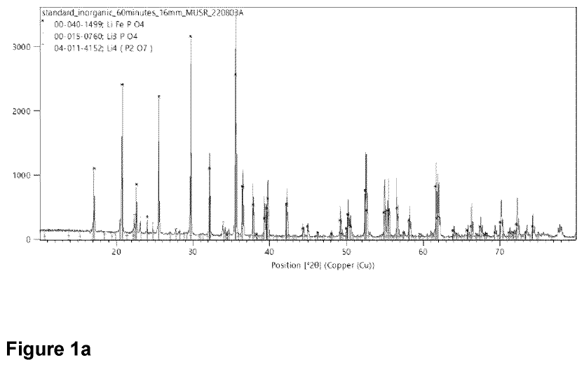

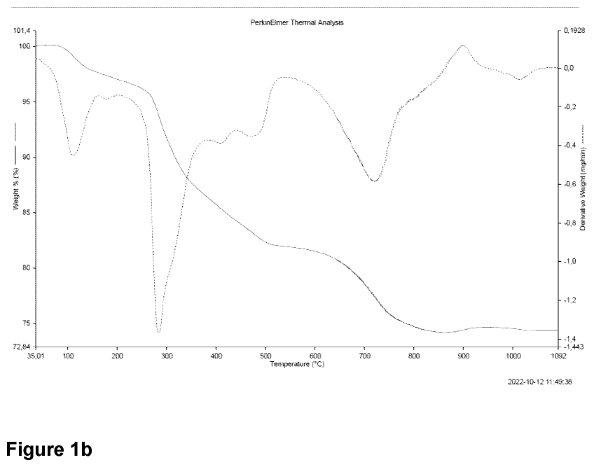

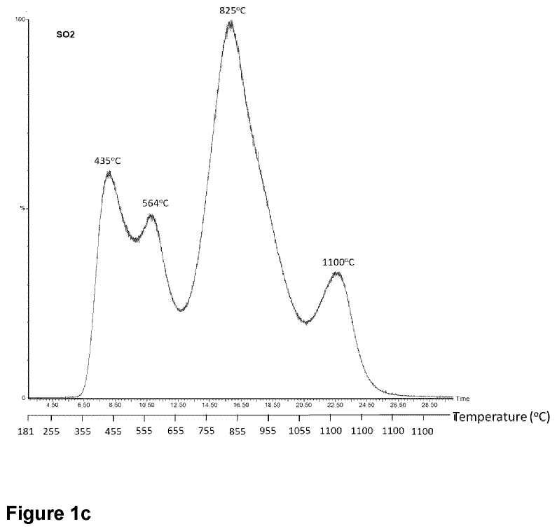

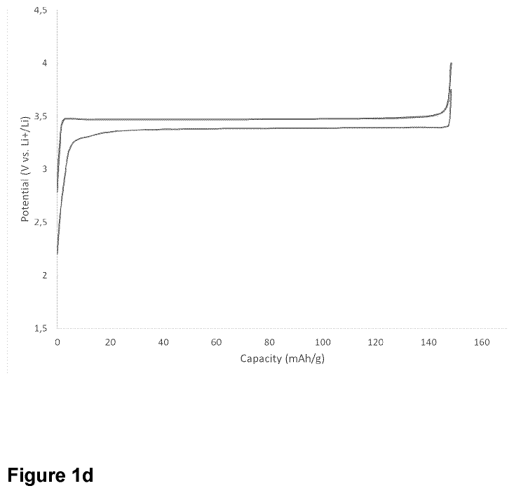

The synthesis is made in a graphite crucible held at 1100° C. for 1 hour under an air atmosphere with a graphite lid to keep a reductive atmosphere within the graphite crucible. After casting under N₂, the product is ground to a powder. XRD analysis confirms the LiFePO₄ olivine structure together with LiₓP_{y}O_{z} impurities due to the starting composition targeted, obtained without Li₂SO₄ peaks as shown in FIG. 1a. A sulfur analysis by LECO confirms less that 0.1% S present in the olivine product confirming the complete lithium sulfate conversion to lithium metal phosphate.

To further confirm the reactional path of this synthesis, a thermogravimetric analysis (TGA) coupled with mass spectroscopy (MS) is done with the same initial powder mixture; see FIG. 1b and FIG. 1c.

The SO₂ released observed by MS confirms the TGA features and the mechanism of formation of the LiFePO₄ olivine according to Eq. 2. The delay observed can be explained by the effect of the rapid temperature increased: 35-1100° C. at 50°/min with a N₂ flow of 10 ml/min.

When the olivine powder obtained is further wet milled to D50 of 200 nm in the presence of a lactose carbon precursor in order to get C—LiFePO₄ with ca. 2% of carbon after pyrolysis at 700° C., a black powder is obtained and found to have an electrochemical capacity greater than 150 mAh/g at a rate of C/10; see FIG. 1d.

### Example 2a

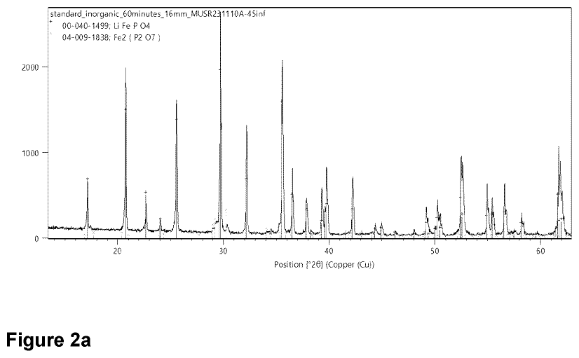

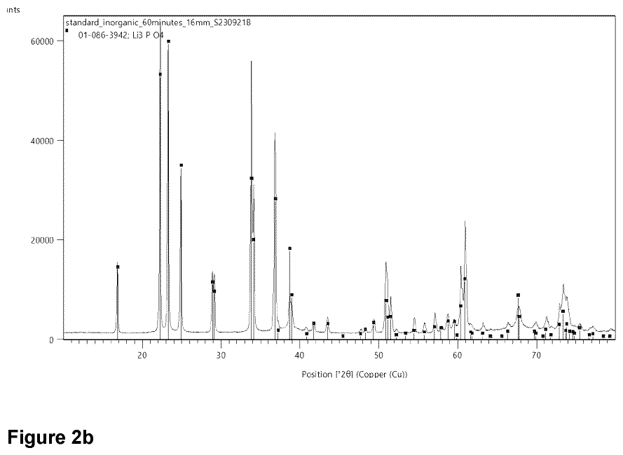

The anhydrous Li₂SO₄ precursor is obtained by drying Li₂SO₄·xH₂O of Example 1 at 200° C. under vacuum. The results obtained are similar as confirmed by the XRD; see FIG. 2a and the reversible electrochemical capacity of 150 mAh/g at a rate of C/10 the C—LiFePO₄ produced therefrom and similar to FIG. 1d.

### Example 2b

Diammonium hydrogen phosphate is added to the leached and neutralized Li₂SO₄ solution of Example 1 to precipitate Li₃PO₄ and the product filtrated along remaining traces of SO₄²⁻ with to attempt to further purification; see FIG. 2b. Residual sulfur detected by LECO being ~0.84% S. When this sulfate-containing lithium precursor is used to form LiFePO₄ as in the two previous examples the product obtained is pure LFP and a sulfur analysis by LECO confirms less that 0.1% S present in the olivine product confirming the complete conversion of any lithium sulfate left.

### Example 3

An LiFe_{0.2}Mn_{0.8}PO₄ powder is prepared using the following mixture of precursors in their solid powder form: Li₂SO₄, Fe⁰, Fe₂O₃, MnCO₃, and P₂O₅.

The proportion of each reactant is adjusted to respect the stoichiometry 1.03, 1, 1.03 for the lithium, iron+manganese, and phosphorus ratio in the final LFMP composition. The two sources of iron are adjusted to fix the oxidation state +2 for the iron and manganese transition metals. The synthesis is made in a graphite crucible held at 1100° C. for 1 hour under a nitrogen atmosphere with a graphite lid to keep a reductive atmosphere within the graphite crucible. After casting under N₂, the product is ground to a powder of less than 75 μm. XRD analysis confirms the LiFe_{0.2}Mn_{0.8}PO₄ olivine structure obtained and the expected cell parameters.

### Example 4

In this example, an LiFePO₄ powder is made using the following mixture of precursors in their solid powder form: Li₂SO₄·H₂O, (NH₄)H₂PO₄, Fe⁰, Fe₂O₃.

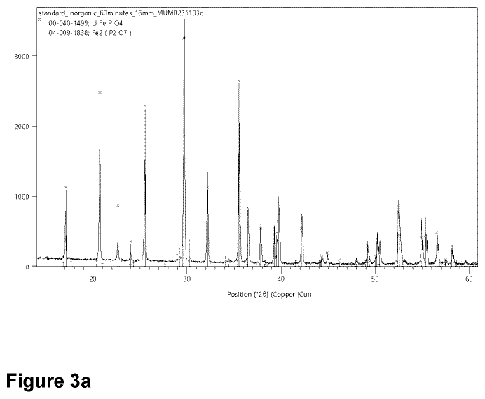

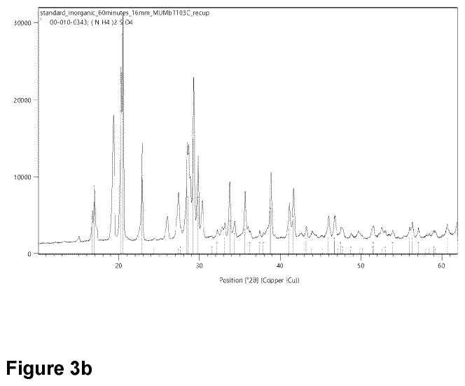

The proportion of each reactant used in the melt process is adjusted to respect to stoichiometry 1.03, 1, 1.03 for the lithium, iron, and phosphorous ratio in the final LFP composition. The synthesis was made in a graphite crucible held at 1100° C. for 1 hour under a nitrogen atmosphere. The sample was then cool down to room temperature in the crucible. The product is then ground to a powder of less than 75 μm. XRD analysis confirms the formation of LifePO₄ olivine structure obtained and the expected cell parameters; see FIG. 3a. A LECO analysis for sulfur in the LFP composition formed is lower than 0.1%.

During the experiment, the gasses released at the exhaust of the furnace were trapped in water. The resulting solution was mainly composed of (NH₄)₂SO₄ as confirmed by the XRD analysis after water evaporation; see FIG. 3b illustrating the possibility to reduce or avoid sulfur anhydrides gas emission by using an MAP or DAP source of P in the melt process along with the Li₂SO₄ precursor of the invention. The by-product (NH₄)₂SO₄ formed to trap sulfur and ammonia having useful applications, e.g., as a fertilizer.

### Example 5

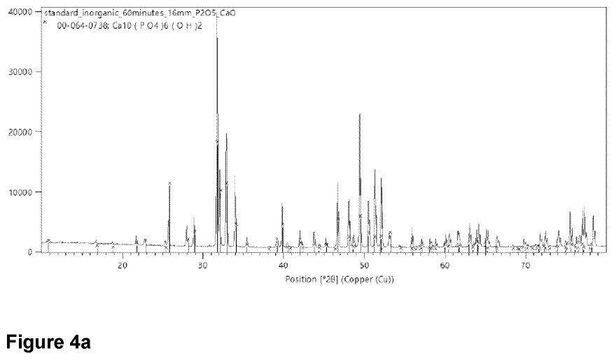

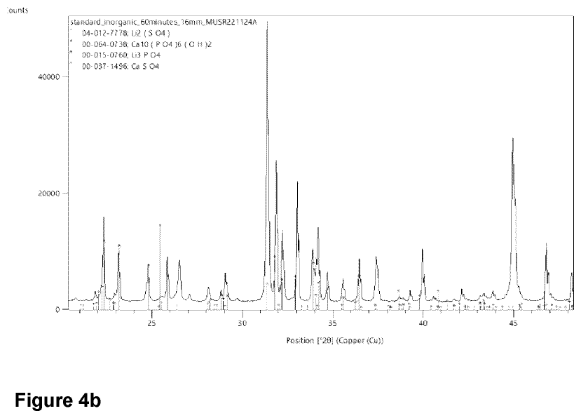

In this example, a concentrated apatite mineral as a source of phosphorus for two different reactions. The apatite XRD shown in FIG. 4a corresponds to Ca₁₀(PO₄)₆(OH)₂.

In a first test an apatite powder and an Li₂SO₄·H₂O powder, in a 3 Li to 1P ratio, are ground together and introduced in a graphite crucible with a graphite lid. The mixture is heated at 1100° C. for two hours. The XRD spectra, FIG. 4b, of the powder obtained from the formed ingot confirms the formation of Li₃PO₄ and CaSO₄ with some unreacted apatite and Li₂SO₄.

Although not an optimized test, the XRD nevertheless confirms the PO₄ to SO₄ substitution to form a lithium phosphate as well as the possibility to in-situ trap the SO₂ released as CaSO₄.

In the second test the same olivine mineral is used as a mixture with the Li₂SO₄·xH₂O and P₂O₅ precursor to form LiFePO₄ using the apatite both as a source of phosphorus (PO₄) and a trap of the sulfur oxide. The Li, Fe, and P reactant powders are ground together in approximate proportion corresponding to the equation:

$$10 {Li}_{2} S {O}_{4} + {( C a )}_{10} {( P {O}_{4} )}_{6} {( O H )}_{2} + 7 {P}_{2} {O}_{5} + 20 FeO = 20 {LiFePO}_{4} + 10 {CaSO}_{4} + {H}_{2} O$$

with an excess of Li₂SO₄. The mixture is introduced in a graphite crucible held at 1150° C. with a graphite lid and a N₂ atmosphere for 2 hours. This example is not optimized to make battery grade LiFePO₄ as such, but it is used to confirm the possibility of using Li₂SO₄ with a concentrate phosphate mineral directly in the melt process of the invention with the additional advantage of trapping the SO₂—SO₃ gas that can be generated during the synthesis as CaSO₄. In this case, a filtration of the solid CaSO₄ is desirable before casting or alternatively a phase separation before or after solidification. The presence of the LiFePO₄ olivine structure peaks is confirmed by XRD after grinding and washing the powder with water to eliminate Li₂SO₄ excess.

### Example 6

The lithium precursor used is a mixture of Li₃PO₄ containing 5% remaining Li₂SO₄ as obtained from a Li₂SO₄ solution after Li₃PO₄ precipitation and filtration. Such a Li and partial PO₄ source is used with Fe⁰, Fe₂O₃, and P₂O₅ precursors in the required proportions to obtain the required Li/Fe/P stoichiometry in the melt. These reactants are introduced in a melt pool of LiFePO₄ held at 1150° C. that is stirred under reducing CO₂/H₂/N₂ atmosphere for ½ hour, the melt composition having the LiFePO₄ stoichiometry before casting and solidification. The XRD confirms pure LiFePO₄ olivine.

### Example 7

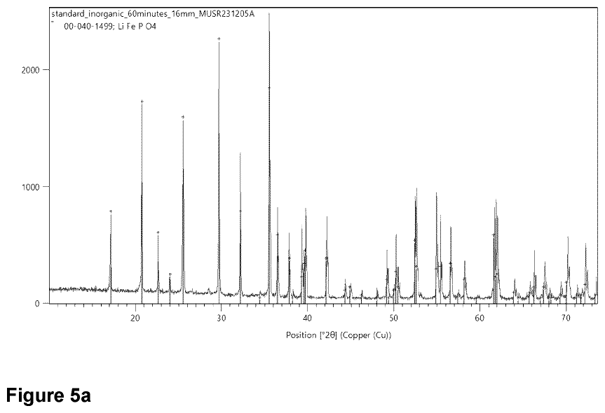

The LFP synthesis is made using not a lithium sulfate precursor but a transition metal sulfate precursor, illustrated using ferrous iron sulfate that is introduced in the melt along with a lithium precursor and a source of phosphate. 21.75 g of FeSO₄, 5H₂O, 3.34 g of Li₂CO₃ and 11.9 g de (NH₄)₂HPO₄ (DAP) are used. The reaction is made in a graphite crucible placed in a tubular furnace. Temperature ramp is 5 C/min to 600° C. followed by 10 C/min to 1100° C. with plateau for one hour before cooling under N₂ in the crucible. Gas emissions are trapped in water and the residue analyzed after evaporation. Product formed in the crucible is crushed to 75 microns or less. XRD pattern of FIG. 5a confirms pure LFP while a LECO S analysis confirm less than 0.1% of S. Evaporated residue is mostly (NH₄)₂SO₄ as showed by XRD. Although not limitative, one possible reaction path may be described as:

$$FeS {O}_{4} \cdot 5 {H}_{2} O + 1 / 2 {Li}_{2} {CO}_{3} + {( {NH}_{4} )}_{2} H ( {PO}_{4} ) -> {LiFePO}_{4} + 5 {H}_{2} O + {CO}_{2} + {( {NH}_{4} )}_{2} {SO}_{4} .$$

One can conclude from this example and the previous ones using lithium sulfate precursors that in the conditions of the melt process of the invention it is possible and advantageous to convert directly and totally a metal sulfate precursor into an equivalent phosphate, LFP, or LFMP.

As will be understood by a skilled person, other variations and combinations may be made to the various embodiments of the invention as described herein above.

The present description refers to a number of documents, the content of which is herein incorporated by reference in their entirety.

The scope of the claims should not be limited by the preferred embodiments set forth herein above; but should be given the broadest interpretation consistent with the description as a whole.

1. A melt process for preparing a lithium metal phosphate (LMP) cathode material, M being at least one transitional metal, the process comprising use of a metal sulfate precursor which is Li₂SO₄, FeSO₄, MnSO₄, or a hydrated form thereof, or a mixture thereof, wherein the metal sulfate precursor is used directly with no significant transformation.

2. The melt process according to claim 1, wherein the metal sulfate precursor is obtained following its extraction from a mine material or recycling from an electrode material of a spent lithium battery; optionally the metal sulfate precursor is obtained as product of a chemical process.

3. The melt process according to claim 1, wherein the LMP cathode material is of the olivine structure; optionally the LMP is lithium iron phosphate (LFP), or lithium iron manganese phosphate (LFMP).

4. The melt process according to claim 1, wherein the mine material is spodumene.

5. The melt process according to claim 1, wherein the metal sulfate precursor is a mixture of the Li₂SO₄ and one of FeSO₄ and MnSO₄.

6. The melt process according to claim 1, wherein the metal sulfate precursor is a mixture of Li₂SO₄, FeSO₄, and MnSO₄.

7. The melt process according to claim 1, wherein;
the Li₂SO₄ precursor is used as a mixture comprising Li₂SO₄ and Li₃PO₄, optionally, the mixture is obtained after subjecting the Li₂SO₄ to a precipitation process; and/or
the Li₂SO₄ precursor is substantially free of Li₂CO₃ or LiOH.

8. (canceled)

9. The melt process according to claim 1, wherein the hydrated form of the Li₂SO₄ precursor of general formula Li₂SO₄·xH₂O, wherein x varies from about 0 to about 30, or from about 1 to about 5, or from about 0 to about 3, or x is 1, or x is 2.

10. The melt process according to claim 1, wherein:
at least one other source of the metal is used; and/or
at least one other source of Fe is used;
preferably the at least other source of Fe is Fe⁰, FeO, Fe₂O₃, Fe₃O₄, ferric phosphate, or a mixture thereof including an iron oxide concentrated mineral;
preferably the sources of Fe are adjusted such as to fix the oxidation state at +2 for Fe.

11. (canceled)

12. The melt process according to claim 1, wherein at least one other source of Mn is used;
preferably the at least other source of Mn is Mn⁰, MnO, Mn₂O₃, MnO₂, MnCO₃, or a mixture thereof.

13. The melt process according to claim 1, wherein;
at least one source of phosphorus or phosphate (source of P or PO₄) is used; preferably the source of P or PO₄ is P₂O₅, HPO₃, (NH₄)H₂PO₄ (monoammonium phosphate; MAP), (NH₄)₂HPO₄ (diammonium phosphate; DAP), or mineral apatite such as Ca₅(PO₄)₃(OH); preferably the source of PO₄ is suitably selected such as to avoid or significantly reduce any emission of SO₂ and/or SO₃ gasses; and/or
at least one source of phosphorus or phosphate (source of P or PO₄) is used which is (NH₄)H₂PO₄ (monoammonium phosphate; MAP) or (NH₄)₂HPO₄ (diammonium phosphate;
DAP), and (NH₄)₂SO₄ is formed as a by-product;
preferably MAP and DAD are used simultaneously with the metal sulfate precursor;
preferably emission of SO₂ and/or SO₃ gasses is eliminated or is significantly reduced.

14. The melt process according to claim 1, wherein:
the metal sulfate precursor is added to the melt simultaneously with the source of PO₄; and/or
the metal sulfate precursor is subjected to an initial melting process thereby obtaining an initial molten reactive pool, and the source of PO₄ is added therein.

15. (canceled)

16. (canceled)

17. The melt process according to claim 2, wherein the mine material or the electrode material of a spent lithium battery is subjected to a treatment comprising thermal treatment and/or acid leaching and/or crystallisation to yield the metal sulfate precursor.

18. The process according to claim 1, wherein:
a temperature of the melt is between about 850° C. and about 1300° C., and a reaction melt is held at substantially the same temperature;
preferably under an inert or reducing atmosphere; preferably the inert or reducing atmosphere comprises CO₂, CO, H₂, H₂O, Ar, N₂, CH₄, and natural gas; preferably in proportions suitable to stabilize the cathode composition in the melt and upon casting and solidification;
preferably under stirring; and/or
the reaction melt is further fixed such that upon casting and solidification the LMP in solid crystalline form is obtained;
optionally the solid crystalline LMP is reduced to powder;
optionally the powdered solid crystalline LMP is coated with carbon to form an electrochemically active cathode material; preferably the carbon coating process uses a carbon precursor.

19. (canceled)

20. A metal sulfate precursor for use directly in a melt process for the preparation of a lithium metal phosphate (LMP) cathode material, M being at least one transitional metal,
wherein the metal sulfate precursor is Li₂SO₄, FeSO₄, MnSO₄, or a hydrated form thereof, or a mixture thereof,
and wherein the metal sulfate precursor is suitable for use directly with no significant transformation;
optionally the metal sulfate precursor is obtained following its extraction from a mine material or recycling from an electrode material of a spent lithium battery; optionally the metal sulfate precursor is obtained as product of a chemical process.

21. An LMP, LFP, or LFMP cathode material made by the melt process as defined in claim 1, which contains about 0.1% or less sulfur as measured by LECO sulfur analysis.

22. A cathode comprising a material made by the melt process as defined in claim 1.

23. A battery having a cathode comprising the material made by the melt process as defined in claim 1.

24. A cathode or battery manufacturing plant which embodies the melt process as defined in claim 1.

25. Use of a metal sulfate precursor in a melt process for preparing a lithium metal phosphate (LMP) cathode material, M being at least one transitional metal, wherein the metal sulfate precursor is Li₂SO₄, FeSO₄, MnSO₄, or a hydrated form thereof, or a mixture thereof,
and wherein the metal sulfate precursor is used directly with no significant transformation; optionally the metal sulfate precursor is obtained following its extraction from a mine material or recycling from an electrode material of a spent lithium battery; optionally the metal sulfate precursor is obtained as product of a chemical process.
